(19) United States
(12) Patent Application Publication
(10) Pub. No.: US 2024/0141179 A1
(43) Pub. Date: May 2, 2024

(54) HIGH TEMPERATURE COATINGS

(71) Applicant: Honeywell International Inc., Charlotte, NC (US)

(72) Inventors: Mehrad Mehr, Raleigh, NC (US); Bahram Jadidian, Watchung, NJ (US)

(21) Appl. No.: 18/182,145

(22) Filed: Mar. 10, 2023

Related U.S. Application Data
(60) Provisional application No. 63/381,810, filed on Nov. 1, 2022.

(51) Int. Cl. C09D 5/32; C09D 1/00; C09D 5/00; C09D 5/26

(52) U.S. Cl. CPC C09D 5/32; C09D 1/00; C09D 5/00; C09D 5/26

(57) ABSTRACT

A space vehicle including a structural component defining a carbon-carbon composite substrate. A high temperature coating on a surface of the carbon-carbon composite substrate. The high temperature coating includes a crystallized metal carbide undercoat on and an overcoat on a surface of the undercoat. The overcoat includes a high emissivity layer. The high emissivity layer has a higher emissivity than the crystallized metal carbide undercoat, and the high emissivity layer includes a complex oxide.

This application claims the benefit of U.S. Provisional Patent Application No. 63/381,810, entitled “HIGH TEMPERATURE COATINGS” and filed on Nov. 1, 2022, which is incorporated herein by reference in its entirety.

### TECHNICAL FIELD

The disclosure relates to high temperature coatings.

### BACKGROUND

Carbon-carbon (C—C) composites may be used in high temperature applications. For example, space industry employs C—C composite components as structural components of space vehicles. In space applications, C—C composites may be susceptible to high temperatures, which may lead to deterioration of physio-mechanical properties.

### SUMMARY

The disclosure describes high-emissivity coatings for carbon-carbon composite substrates that protect space vehicle components against high temperatures, and techniques for making the same. Since space vehicles are configured to operate in space, the components may be configured to withstand the extremely high and low temperatures of space travel, where thermal management of components by convective or conductive heat transfer is less available due to the lack of an atmosphere in outer space. The component substrate may be coated with a high temperature coating, which may include a crystallized metal carbide undercoat and an overcoat that includes a high emissivity layer on the undercoat. The undercoat may include a metal carbide formed in situ on the substrate, which may protect the carbon-carbon substrate from oxidation and provide a bond surface for the overcoat. The high temperature coating also includes an overcoat which includes a high emissivity layer, which may advantageously improve radiative cooling from the component relative to an uncoated carbon-carbon composite component or a C/C component coated with only the undercoat layer. Thus, the component may be radiatively cooled during space travel.

In some examples, the disclosure is directed to a space vehicle. The space vehicle includes a structural component defining a carbon-carbon composite substrate. The C/C substrate is coated with a high temperature coating that includes a crystallized metal carbide undercoat on a surface of the carbon-carbon composite substrate. The high temperature coating includes an overcoat on a surface of the undercoat. The overcoat comprises a high emissivity layer. The high emissivity layer has a higher emissivity than the crystallized metal carbide undercoat. The high emissivity layer comprises a complex oxide.

In some examples, the disclosure is directed to a technique which includes forming a crystallized metal carbide undercoat on a surface of a carbon-carbon composite substrate of a structural component of a space vehicle. The technique also includes forming an overcoat on a surface of the undercoat. The overcoat includes a high emissivity layer, and the high emissivity layer has a higher emissivity than the crystallized metal carbide undercoat. The high emissivity layer comprises a complex oxide.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a perspective view diagram illustrating an example component that includes a high temperature coating formed in accordance with the techniques of this disclosure.

FIG. 2 is a schematic side view diagram of an example space vehicle component that includes a high temperature coating formed in accordance with the techniques of this disclosure.

FIG. 3 is a flow diagram illustrating an example technique for forming a high temperature coating, according to examples of the disclosure.

FIG. 4 illustrates the reflectance of an example component including a surface having a high temperature coating according to the present disclosure, across a range of wavelengths.

### DETAILED DESCRIPTION

Carbon-carbon (C/C) composite components are used as structural components in space vehicles. C/C components are chosen because they provide good mechanical properties and have low mass density relative to other materials, such as metal alloys. However, at high temperatures, carbon-carbon composite components may be susceptible to oxidation, environmental attack, and degradation of physio-mechanical properties.

Further complicating the situation, space vehicles are configured to operate in outer space, which may be a vacuum environment or a near vacuum environment. As such, structural components may be exposed to short term exposure to temperature cycles of up to 3000 degrees Fahrenheit (° F.), with long term exposure to temperatures of up to 2500° F. Furthermore, outer space may lack an atmosphere, making conductive and convective heat transfer away from structural components difficult or impossible. Thus, radiative cooling may be of increased importance. The relative power of a surface to emit heat by radiation is called its emissivity. Although the emissivity of a surface can be broken down into its emissivity at certain wavelengths of interest, emissivity as generally described herein refers to the total emissivity across the entire spectrum of thermal radiation. The emissivity of a surface is measured by a dimensionless number that varies between 0, for a perfect reflector, and 1, for a perfect emitter, or black body. It may be desirable to increase the emissivity of a structural component with a C/C substrate surface because the emissivity of the bare C/C component substrate surface may be around 0.8, which may not be high enough to provide the required thermal radiation from the surface, resulting in the bare C/C substrate overheating and failing.

To combat the deleterious effects of high temperatures and operation in outer space, one or more surfaces of the C/C component may be covered with a high temperature coating. High temperature coatings of the present disclosure include both a crystallized metal carbide undercoat and an overcoat which includes a high emissivity layer. The crystallized metal carbide undercoat may be configured to provide oxidation resistance and a bond surface for bonding the overcoat to the C/C substrate. Although the crystallized metal carbide undercoat may impart desired antioxidant and temperature resistance qualities to the C/C substrate, the crystallized metal carbide undercoat may have an emissivity of around 0.7, which may not be high enough to provide the required thermal radiation from the surface of space vehicle structural components. Components coated with only a crystallized metal carbide may overheat and subsequently fail during periods of high temperature in space or upon re-entry.

High temperature coatings of the present disclosure also include an overcoat which includes a high emissivity layer relative to the undercoat. The high emissivity layer of the overcoat includes a complex oxide, which is a chemical compound that contains oxygen and at least two other elements or oxygen and one other element it at least two oxidation states. The high emissivity layer may increase emissivity of the surface of the C/C substrate relative to a component surface coated with only the undercoat, improving thermal radiation and radiative cooling of the structural component. Accordingly, the temperature of the component may be maintained below a failure threshold. The combination of the undercoat and overcoat may thus provide a combination of properties that allow for successful use and/or reuse of structural components of space vehicle because of the enhanced dissipation of thermal energy and cooler components in service In some examples, the disclosed high temperature coatings which include both an undercoat which includes a crystallized metal carbide and an overcoat which includes a complex oxide may withstand hundreds of cyclic temperature exposures without failure, allowing for re-use of structural components that have substrate surfaces covered with the high temperature coatings.

The overcoat may also be configurable to provide other desirable properties. For example, the overcoat may further provide for abrasion resistance, which may protect the undercoat and substrate from impact, such as from flying debris or ice. In some examples, the overcoat may be formed as a single layer which provides both high emissivity relative to the undercoat and high abrasion resistance relative to the undercoat. Alternatively, the overcoat may be formed from two or more layers, such as a plurality of layers, with one or more of the overcoat layers tailored to provide increased emissivity and one or more of the plurality of layers tailored to provide increased abrasion resistance.

The high temperature coatings described herein may be formed using any suitable process. In some examples, the undercoat may be formed by reacting carbon of the C/C substrate with a metal to convert the surface of the C/C component to a metal carbide. In some examples, the metal may be maintained at stoichiometric excess to create a metal-rich metal carbide undercoat, which may advantageously improve the oxidation resistance of the undercoat layer. The resulting crystallized metal carbide undercoat on a surface of the substrate may strongly adhere to both the underlying substrate and to an adjacent overcoat. The undercoat and may have self-healing functionality through metal oxides formed in microcracks of the undercoat.

Subsequent to forming the undercoat, the overcoat layer or overcoat layers may be formed by any suitable process, including for example, a slurry deposition process, a thermal spray process, a physical vapor deposition process, or an alternative process. The slurry deposition process may be a relatively simple, inexpensive process that also allows for customization of the overcoat for particular application. In this example, each overcoat layer may be formed by applying a slurry to an outer surface of an underlying layer, such as through relatively routine coating processes (e.g., brush or spray painting). The slurry may include one or more complex oxide ceramic material(s) and one or more sintering aids and/or other components. After application of the slurry, the slurry may be heated to pyrolyze and crystallize the complex oxide into a ceramic matrix. The resulting overcoat layer may be substantially (e.g., greater than 95% by volume) crystallized and free of glass (e.g., less than 5% by volume). The resulting overcoat layer which includes a complex oxide may have a higher emissivity than the undercoat layer, and the increased emissivity may improve radiative cooling of the part. In some examples, the high emissivity layer of the overcoat may have an emissivity of at least about 0.90, or at least about 0.95, or at least about 0.98, or at least about 0.99. Inclusion of the high emissivity layer as all or part of the overcoat may increase the emissivity of the surface of the C/C component to a level close enough to 1, the emissivity provided by a theoretical black body, to allow the C/C component to achieve a service temperature that is low enough to survive a space flight and be reused during a second, subsequent space flight.

This application and heating process may be repeated to form one or more additional overcoat layers. The slurry for each layer may be customized to provide specific and tailored properties to the overcoat through individual overcoat layers and/or a combination of overcoat layers. For example, particle size and distribution, particle composition, complex oxide composition, or other parameters used to form one or more respective overcoat layers may be selected to provide particular thermomechanical and thermophysical properties to respective overcoat layers and/or the overall overcoat, such as coefficient of thermal expansion, porosity, thermal conductivity, or thermal stability (e.g., melting point). As a result, particular overcoat layers may have improved properties for a particular depth in the overcoat and/or improved properties relative to adjacent layers or coatings. For example, an outermost overcoat layer near a surface of the overcoat may have a higher emissivity than underlying overcoat layers, such as, for example, by inclusion of a high emissivity particle (e.g., a roughened metal oxide such as a rare earth oxide) as a dopant. In some examples, the overcoat may include a plurality of overcoat layers progressing from an outermost “exterior” overcoat layer to an innermost “interior” overcoat layer. The plurality of overcoat layers may form a gradient of CTE to reduce mismatch of CTE between adjacent layers or a gradient of decreasing thermal conductivity to reduce heat transfer to the substrate. In this way, high temperature coatings described herein may allow a high degree of tailorability for a particular high temperature application.

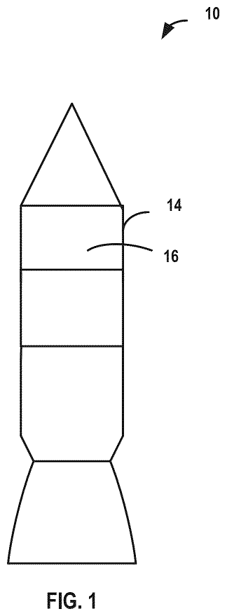

High temperature coatings described herein may be especially suited to coating space vehicles which include C/C structural components, due to high temperatures and extreme environments involved in such applications. FIG. 1 illustrates an example of carbon-carbon composite component used as a structural component of a space vehicle.

FIG. 1 is a conceptual diagram illustrating a simplified example space vehicle 10 that includes a carbon-carbon composite component 14 having surface 16 that includes a high temperature coating (not shown individually in FIG. 1) formed in accordance with the techniques of this disclosure. In the example of FIG. 1, carbon-carbon composite component 14 is a structural component of the vehicle.

Space vehicle 10 may be any vehicle designed to enter the physical universe beyond earth's atmosphere, including any unmanned vehicle such as a satellite or manned vehicle such as a shuttle. Structural component 14 may be any suitable structural component of the vehicle, such as a thrust component or a component of a re-entry vehicle which is configured to return to earth's atmosphere after traveling into outer space. As a result of heat exposure during launch, re-entry, or and/or travel in outer space (e.g., thermal radiation from the sun), carbon-carbon composite 14 may experience high temperatures (e.g., 3,000° F.). Carbon-carbon composite 14 includes a substrate that includes surface 16 exposed to an outer atmosphere. To protect the carbon-carbon composite substrate from extreme temperatures, surface 16 may include a high temperature coating.

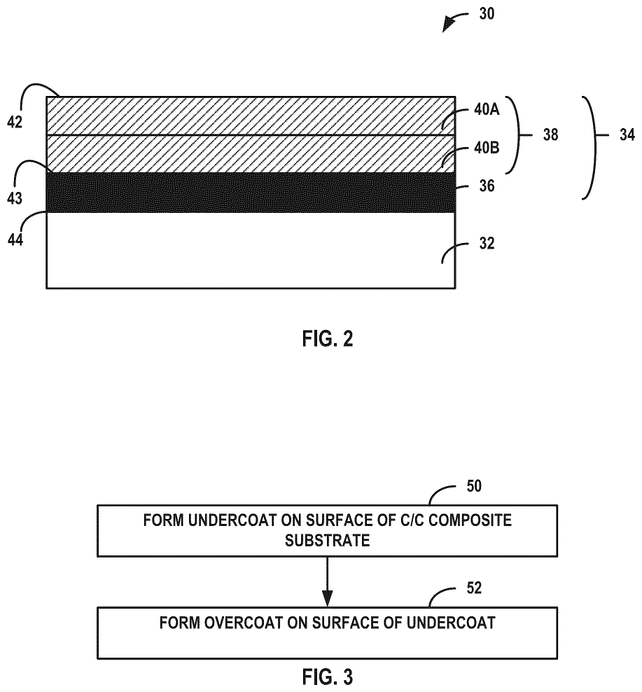

FIG. 2 is a schematic side view diagram of a component 30 that includes an example high temperature coating 34, according to examples of the disclosure. Component 30 includes a carbon-carbon composite substrate 32. Substrate 32 may include carbon-based reinforcement fibers and a carbon-based matrix material at least partially surrounding the carbon-based reinforcement fibers. In some examples, substrate 32 may be formed form a porous preform that includes carbon fibers or carbon-precursor fibers. Examples of porous preforms that may be used to produce substrate 32 include, but are not limited to: a fibrous preform, such as a woven fiber preform, a nonwoven fiber preform, a chopped-fiber and binder preform, a binder-treated random fiber preform, a carbon fiber preform, or a ceramic fiber preform; a foam preform; a porous carbon body preform; or a porous ceramic body preforms.

In some examples, the porous preform includes a plurality of mechanically bound layers, which can be, for example, a plurality of fibrous layers, such as a plurality of woven or nonwoven fabric layers, connected together, e.g., bound by a binder, such as a resin binder, or via needle-punching of the plurality of layers. In some examples, the layers include one or more tow layers, one or more web layers, or combinations thereof. Tow layers may include one or more tows of fibers. Tows of fibers may be arranged in any suitable arrangement including, for example, linear, radial, chordal, or the like. Web layers may include web fibers, which may include relatively short, chopped, and entangled fibers of fibers. In other examples, the porous preform may not include predefined layers, but, rather, may be formed from a bundle of fibers that are mechanically bound together, e.g., via needling. In other examples, a combination of any of the aforementioned types of porous preforms can be used.

Substrate 32 may also include a matrix material that at least partially encapsulates the carbon fibers. The matrix material may be introduced into the porous preform using one or more of a variety of techniques, including, for example, chemical vapor deposition/chemical vapor infiltration (CVD/CVI), resin transfer molding (RTM), vacuum/pressure infiltration (VPI), high pressure impregnation/carbonization (PIC), or the like.

Substrate 32 may be subject to high temperatures during operation. As one example, component 30 which defines carbon-carbon composite substrate 32 may be an example of structural component 14 of space vehicle 10 of FIG. 1. As such, substrate 32 may be subject to temperatures as high as about 3,000 degrees Fahrenheit (° F.) (about 1,649° C.) during short term exposure periods. As another example, carbon-carbon composite substrate 32 of space vehicles may be subject to temperatures as high as about 2,500° F. (about 1,371° C.) during operation. To protect substrate 32 from high temperatures, component 30 includes a high temperature coating 34 on one or more surfaces of substrate 32. Coating 34 may be stable at temperatures of up to about 3,000° F. (about 1,649° C.). In this context, “stable” may mean that coating 34 does not degrade into its constituent elements, does not react with carbon, and/or does not react with other elements or compounds present in the environment in which coating 34 is used including, but not limited to, oxidation. Coating 34 may have any suitable thickness. In some examples, a thickness of coating 34 may be from about 0.0254 millimeters (mm) to about 20 mm. In some examples, a thickness of coating 34 may correspond to an application or expected length of service of article 30, such that a longer length of service may correspond to a higher thickness of coating 34. In some examples, a thickness of coating 34 may be configured to control a temperature drop (ΔT) from exterior surface 42 to interior surface 44 of coating 34, such that when exterior surface 44 is exposed to an extreme temperature such as 3,000° F. (about 1,649° C.), the thickness of coating 34 may have a known thermal conductivity such that the thickness of coating 34 may be configured to keep substrate 32 below a threshold temperature where its physio-mechanical properties are compromised.

Coating 34 includes an undercoat 36 on a surface of substrate 32 (e.g., directly on substrate 32 or indirectly on substrate 32 through one or more intermediate layers). Undercoat 36 includes one or more substantially crystallized (e.g., greater than about 95% by volume crystalline phase) metal carbide layers. In some examples, undercoat 36 may include at least one of silicon carbide (SiC), titanium carbide (TiC), tungsten carbide (WC), zirconium carbide (ZrC), combinations thereof, or any carbide layer formed using the principles of the process described in U.S. Pat. Nos. 6,555,173 and/or 4,837,073, which are incorporated by reference herein in their entirety.

Undercoat 36 may be configured to reduce delamination, spallation, and/or cracking of coating 34. Undercoat 36 may experience high temperatures that may exacerbate shear forces caused by differences in coefficient of thermal expansion between undercoat 36 and either/both substrate 32 and/or an adjacent coating of overcoat 38. To maintain these forces relatively low, undercoat 36 may have a coefficient of thermal expansion that is relatively similar to a coefficient of thermal expansion of substrate 32, overcoat 38, or both. For example, undercoat 36 may have a coefficient of thermal expansion that is within a range between about 4 parts per million per degree Celsius (ppm/° C.) and about 4.5 ppm/° C. In some examples, undercoat 36 may be chemically compatible with substrate 32, overcoat 38, or both. For example, undercoat 36 may have a selected wettability relative to substrate 32, overcoat 38, or both.

In some examples, undercoat 36 may be configured to increase adhesion between overcoat 38 and substrate 32. For example, as will be explained further below, undercoat 36 may be formed from an in situ process that involves reaction between reactive carbon and metal in stoichiometric excess. The excess metal may form a metal oxide that may migrate into microcracks of substrate 32, undercoat 36, and/or overcoat 38 to provide a self-healing functionality. The metal oxide may more strongly adhere to a ceramic matrix of overcoat 38, and/or may be at least partially impregnated into open pores of substrate 32. Additionally or alternatively, undercoat 36 may have a relatively low thickness, such as less than about 20 micrometers, and/or consistent thickness, such as within about 10 micrometers, that is controlled by an amount of reactive carbon present on substrate 32.

Component 30 includes an overcoat 38 on a surface of undercoat 36 (e.g., directly on undercoat 36 or indirectly on undercoat 36 through one or more intermediate layers). Overcoat 38 may span from exterior surface 42 to interior overcoat surface 43 which interfaces with undercoat 36. Overcoat 38 may be configured to provide improved emissivity of substrate 32 compared to a substrate 32 coated with undercoat 36 alone. Additionally, in some examples overcoat 38 may reduce or prevent migration of reactive oxidizing species into substrate 32 at high temperatures, and/or provide abrasion resistance to protect undercoat 36 and substrate 32 from impact from particles, flying debris, ice, or the like. Overcoat 38 includes one or more overcoat layers 40. In the example of FIG. 2, two overcoat layers 40A and 40B are shown; however, overcoat 38 may include any number of overcoat layers 40. For example, overcoat 38 may include a single overcoat layer 40. Single overcoat layer 40 may be configured to act as both the high emissivity layer of overcoat 38 and abrasion resistant layer of overcoat 38 which is more abrasion resistant than undercoat 36 and is configured to protect undercoat 36 and substrate 32 from impact. Alternatively, overcoat 38 may include between two and ten overcoat layers 40, including outermost overcoat layer 40B and innermost overcoat layer 40B.

In the example of FIG. 2, overcoat 38 includes exterior overcoat layer 40A and interior overcoat layer 40B. Exterior overcoat layer 40A is a high emissivity layer in the illustrated example. High emissivity exterior overcoat layer 40A has a higher emissivity than undercoat 36. For example, exterior overcoat layer 40A may define exterior surface 42, and exterior surface 42 may have an emissivity of about 0.90 or at least about 0.95, or at least about 0.98, or at least about 0.99. High emissivity exterior overcoat layer 40A may include a complex oxide which provides for the increased emissivity of the exterior overcoat layer 40A. In some examples, a magnitude of the difference between a coefficient of thermal expansion (CTE) of the high emissivity layer of the overcoat and a CTE of the carbon-carbon composite substrate is less than 2 parts per million per degree Celsius (ppm/° C.). In some examples, exterior layer 40A and interior layer 40B of overcoat 38 may include a ceramic matrix, and the ceramic layers have at least one of a different coefficient of thermal expansion or a different thermal conductivity.

In the example of FIG. 2, overcoat 38 also includes interior overcoat layer 40B. In some examples, the composition of interior overcoat layer 40B may be substantially similar to (e.g., the same as or nearly the same as) the composition of exterior overcoat layer 40A, but be applied to undercoat 36 prior to the application of exterior overcoat layer 40A. However, in some examples, interior layer 40B may be tailored to provide maximum abrasion resistance rather than maximum emissivity. Although described herein as the high emissivity layer being exterior layer 40A of overcoat 38, in some examples the high emissivity layer of overcoat 38 may be interior layer 40B and the abrasion resistant layer may be exterior layer 40A.

In some examples, although not illustrated in FIG. 2, one or more intermediate overcoat layers 40 may be disposed between exterior overcoat layer 40A and interior overcoat layer 40B, providing a relatively gradual gradient of emissivity, abrasion resistance, coefficient of thermal expansion and/or thermal conductivity. Each overcoat layer 40 of overcoat 38 may include a ceramic matrix. In some examples, the ceramic matrix be a complex oxide matrix, or may include a plurality of complex oxide particles within the ceramic matrix. For example, the ceramic matrix may form a continuous phase and the plurality of complex oxide particles may form a dispersed phase within the continuous phase.

The complex oxide of the high emissivity layer of overcoat 38, which is layer 40A in FIG. 2, may include any complex oxide material. A complex oxide material includes a compound that contains oxygen and at least two other elements, or oxygen and just one other element that is in at least two oxidation states. In some examples, the complex oxide of the high emissivity layer of the overcoat comprises a rare earth silicate. Exterior overcoat layer 40A including a rare earth silicate may advantageously provide both increased emissivity and increased abrasion resistance relative to undercoat 36, and meet the high temperature stability requirements of high temperature coating 34. Thus, a single overcoat layer 40 may make up overcoat 38, and the single overcoat layer may be both the high emissivity layer and the abrasion resistant layer. The single overcoat layer may have a relatively simple and elegant composition that consists of or consists essentially of one or more rare earth silicates. The overcoat layer consisting of a rare earth silicate may provide sufficient emissivity, abrasion resistance, and stability to make up overcoat 38. Suitable rare earth elements of the rare earth silicate may include neodymium (Nd), yttrium (Y), lanthanum (La), scandium (Sc), dysprosium (Dy), terbium (Tb), europium (Eu), praseodymium (Pr), samarium (Sm), cerium (Ce), gadolinium (Gd), holmium (Ho), lutetium (Lu), thulium (Tm), ytterbium (Yb), erbium (Er), and/or promethium (Pm).

In some examples, the complex oxide of the high emissivity layer of the overcoat includes a rare earth (RE) disilicate with general formula RE₂Si₂O₇, or a rare earth monosilicate with general formula RE₂SiO₅, or mixtures or combinations thereof. Rare earth disilicates may provide increased emissivity over other complex oxides, and thus may be advantageous in some examples. In some examples, the complex oxide of the high emissivity layer of overcoat 38 may include two or more rare earth cations, such a rare earth disilicate may have general formula (RE1_{X}RE2_{Y})₂Si₂O₇. In some examples, X may be between about 0.05 and about 0.3, and Y may be between about 0.7 and about 0.95. A “doped” rare earth disilicate layer, as such, may yield a high emissivity layer which nearly approaches the ideal blackbody emissivity of 1, such as an emissivity of about 0.95, or about 0.98, or about 0.99. In some examples, the doped disilicate layer may include both yttrium and ytterbium, which may be relatively inexpensive as compared to other rare earth materials, may have relatively high emissivity performance compared to other rare earth materials, or both.

In some examples, the high emissivity exterior overcoat layer 40A of overcoat 38 may include a plurality of high-emissivity particles dispersed within the ceramic matrix over exterior overcoat layer 40A. For example, a roughened oxidized metal particle such as a rare earth oxide, or another high emissivity particle may further improve the emissivity of the high emissivity exterior overcoat layer 40A. In some examples, the high emissivity particles may be dispersed within high emissivity exterior overcoat layer 40A at a weight percent fraction of about 0.01 weight percent to about 10 weight percent.

In some examples, overcoat layer 40 may be derived from a slurry of complex oxide ceramic material which can be applied on substrate 32 by brush coating, air-brushing, or airless spray systems, which may be more applicable to large surfaces (16, FIG. 1) than other deposition techniques such as physical vapor deposition techniques, which also may be used. In some examples, the slurry may also include one or more sintering aids. After application of the slurry, substrate 32 may undergo one or more heat treatments, which may evaporate and/or pyrolize components of the slurry and cure the overcoat layer 40. In some examples, the heat treatment may crystallize ceramic material of the slurry, which, once substantially crystallized, maintains thermal and chemical stability above about 1500° C. A composition of the ceramic material may be selected for a variety of properties including, but not limited to, a decomposition temperature of the ceramic material, a crystallization temperature for one or more crystalline phases of the ceramic material, a coefficient of thermal expansion of the ceramic material, a thermal conductivity of the ceramic material, a porosity of the ceramic material, mechanical properties of the ceramic material, compatibility and adhesion with the ceramic particles, and the like. The ceramic matrix may be substantially crystallized, such that the ceramic matrix is substantially free of glass/amorphous phases. For example, the ceramic matrix may include one or more crystalline phases distributed in an amorphous phase, such that the amorphous phase is less than about 5% by volume of the ceramic matrix.

In the example of FIG. 2, overcoat 38 includes two or more overcoat layers 40 that enable properties of overcoat 38 to be varied along a depth (or z-axis) of overcoat 38 (e.g., normal to a surface of substrate 32). Two or more overcoat layers 40 within overcoat 38 may have different emissivity, different impact resistance, different abrasion resistance, different porosities, different thermal expansion properties, different thermal conductivities, different thicknesses, different melting points, and/or other variations in physical or chemical properties.

In some examples, the combination of overcoat layers 40 may define one or more gradients of one or more properties within overcoat 38 or one or more differences in one or more properties between two or more overcoat layers 40 within overcoat 38. For example, certain properties of overcoat 38 may be more or less important at particular depths or positions within overcoat 38 based on a proximity of a portion of overcoat 38 to exterior surface 42 or inner layer 43 of overcoat 38.

As one example, overcoat layers 40 may form a composition gradient through overcoat 38 or have a composition difference between two or more overcoat layers 40 within overcoat 38. For example, one or more species within overcoat layer 40A nearest substrate 32 and undercoat 36 may be more likely to migrate into or interact with a species in substrate 32 or undercoat 36. In the example of FIG. 2, a composition of overcoat layer 40B nearest substrate 32 and undercoat 36 may be more chemically compatible with substrate 32 and/or undercoat 36 compared to the composition of overcoat layer 40A.

As another example, overcoat layers 40 may form a porosity gradient through overcoat 38 or have a porosity difference between two or more overcoat layers 40 within overcoat 38. In the example of FIG. 2, a porosity of overcoat layer 40B nearest substrate 32 and undercoat 36 may be lower, and therefore more dense, compared to a porosity of overcoat layer 40A further from substrate 32 and/or undercoat 36. In some examples, managing porosity in this way may change a surface roughness of exterior surface 42, which may impact the emissivity of exterior layer 42.

As another example, overcoat layers 40 may form a thermal conductivity gradient through overcoat 38. For example, a high temperature of an external atmosphere in contact with overcoat 38 may damage substrate 32, such that one or more overcoat layers 40 within overcoat 38 may have a relatively low thermal conductivity to limit heat transfer to underlying layers or substrates, such as substrate 32. In the example of FIG. 2, a thermal conductivity of overcoat layer 40B nearest substrate 32 and undercoat 36 may be higher than a thermal conductivity of overcoat layer 40A.

As another example, overcoat layers 40 may form a coefficient of thermal expansion (CTE) gradient through overcoat 38. For example, a CTE of substrate 32 and/or undercoat 36 may be substantially different, such as substantially lower, than a CTE of an outermost exterior overcoat layer 40A, which may be tailored to maximize emissivity, so the CTE of exterior overcoat layer 40A may be allowed to vary from substrate 32. To reduce interlaminar forces between substrate 32, undercoat 36, and overcoat layers 40 of overcoat 38 caused by differences in thermal expansion at high temperatures, overcoat layers 40 may form a CTE gradient that incrementally changes between substrate 32 or undercoat 36 and an outermost overcoat layer 40A (or other overcoat layer 40) in overcoat 38. In the example of FIG. 2, a CTE of overcoat layer 40B may be between a CTE of undercoat 36 and a CTE of overcoat layer 40A.

As another example, overcoat layer 40 may form a thermal stability gradient through overcoat 38. For example, a temperature of one or more outer overcoat layers 40 of overcoat 38 may experience higher temperatures than other inner overcoat layers 40, such that the one or more outer overcoat layers 40 may have higher degradation or melting temperatures than the inner overcoat layers 40. In the example of FIG. 2, a degradation or melting point of overcoat layer 40B (e.g., components within overcoat layer 40B) may be lower than a degradation or melting point of overcoat layer 40A which defines outer surface 42 of overcoat 38.

Parameters and compositions of the complex oxides of each layer may be selected to provide overcoat 38 with various properties described above. By configuring overcoat layers 40 to have different compositions or parameters, overcoat 38 may be configured to provide excellent emissivity (e.g., >0.90, or >0.95, or >0.98, or >0.99), excellent abrasion resistance, conductivity through overcoat 38 to substrate 32, improve oxidation and/or environmental attack resistance of overcoat 38, and/or improve mechanical properties of component 30 compared to a coating that does not include an undercoat which includes a metal carbide and an overcoat which includes a high emissivity layer that includes a complex oxide.

FIG. 3 is a flow diagram illustrating an example technique for forming a high temperature coating, according to examples of the disclosure. The technique of FIG. 3 will be described with respect to component 30 of FIG. 2; however, the technique of FIG. 3 may form other components that include high temperature coatings, such as with a greater number of layers or fewer number of layers.

The technique of FIG. 3 includes forming crystallized metal carbide undercoat 36 on a surface (16, FIG. 1) of substrate 32 (50). In some examples, undercoat 36 may be formed in situ using a metal-rich combination of one or more carbon coatings and one or more metal coatings. Forming undercoat 36 may include cleaning the surface of substrate 32, applying a reactive carbon coating on the surface of substrate 32, such as through brush coating, and drying the carbon coating. Forming undercoat 36 may further include applying a metal coating on the carbon coating and drying the metal coating. The metal coating may be applied at a metal-rich, stoichiometric excess. Forming undercoat 36 may further include heating the carbon coating and metal coating to a heat treatment temperature. The heat treatment temperature may be sufficiently high to mobilize the metal of the metal coating, such as through melting, and react the metal with the carbon of the carbon coating to form a crystallized metal carbide. The metal carbide may be further heated to further alter the microstructure, phase composition, or other properties or characteristics of the metal carbide. Excess metal from the metal coating may migrate into pores of substrate 32. The resulting undercoat 36 may include a metal carbide portion on the surface of substrate 32 and a metal portion extending into substrate 32.

The technique of FIG. 3 also includes forming overcoat 38 on a surface of undercoat 36 (52). In some examples, each overcoat layer 40 may be sequentially formed by applying a slurry to a surface of an underlying layer. The slurry may include includes a complex oxide. The complex oxide of the slurry may be selected for desired properties of a resulting evaporated or pyrolyzed, crystallized ceramic matrix. The slurry may include one or more sintering aids. A variety of methods may be used to apply the slurry to an underlying layer. In some examples, the mixture is applied using at least one of brush painting or spray painting. For example, brush or spray painting may be relatively inexpensive and may form relatively thin layers, such that overcoat 38 may include a large number of layers while remaining relatively thin. In some examples, the technique of FIG. 3 may include heating, in an inert atmosphere or under vacuum, the slurry to a heat treatment temperature to pyrolyze or evaporate components of the slurry to form the overcoat layer 40, which includes the complex oxide. The heat treatment temperature may be sufficiently high to pyrolyze components of the slurry and form a ceramic matrix. The heat treatment temperature may also be sufficiently high to crystallize the ceramic matrix. For example, the heat treatment temperature may be sufficiently high to convert most or all of a glassy phase into one or more crystalline phases. In some examples, heat treatment temperature may be greater than about 1800° F. for several hours, such as about 2600° F.

Forming overcoat 38 may include forming two or more overcoat layers 40. As one example, to form two overcoat layers 40A and 40B illustrated in FIG. 2, the technique may include applying a first slurry to a surface of undercoat 36 and subsequently heating the first slurry to form a first overcoat layer 40B. To form a subsequent layer, the technique may include applying a second slurry to a surface of first overcoat layer 40B and subsequently heating the second slurry to form second overcoat layer 40B. This process of application of a mixture and heating of the mixture to form an overcoat layer 40 may be repeated until a desired number of overcoat layers 40 are formed.

Overcoat 38 includes high emissivity layer 40A. High emissivity layer 40A has a higher emissivity than undercoat 36, and high emissivity layer 40A includes a complex oxide. In some examples, high emissivity layer 40A defines exterior surface 42, and exterior surface 42 has an emissivity of at least about 0.90 or at least about 0.95. In some examples, forming the overcoat includes forming a single layer consisting of high emissivity layer 40A. High emissivity layer 40A may be relatively more abrasion resistant than undercoat 36, and thus high emissivity layer 40A may be configured to protect undercoat 36 from impact. In some examples, forming overcoat 38 may further include forming abrasion resistant layer 40B in addition to forming high emissivity layer 40A, such that abrasion resistant layer 40B is different than high emissivity layer 40A and abrasion resistant layer 40B is more abrasion resistant than undercoat 36.

In some examples, high emissivity layer 40A may define exterior layer 42 of overcoat 38. Alternatively, the abrasion resistant layer may be formed over the high emissivity layer. In some examples, a magnitude of the difference between a coefficient of thermal expansion (CTE) of high emissivity layer 40A of overcoat 38 and a CTE of carbon-carbon composite substrate 32 may be less than about 2 ppm/° C., such as less than 1 ppm/° C.

In some examples, the complex oxide of high emissivity layer 40A of overcoat 38 includes a rare earth silicate. In some examples, the complex oxide of high emissivity layer 40A includes a rare earth disilicate, which may improve the emissivity of high emissivity layer 40A. In some examples, the complex oxide of high emissivity layer 40A of overcoat 38 includes two or more rare earth cations. In some examples, a plurality of high-emissivity particles, such as a roughened metal oxide, may be dispersed in the ceramic matrix.

Each overcoat layer 40 may have a resulting CTE and thermal conductivity. In some examples, various overcoat layers 40 between an outermost exterior overcoat layer 40B and undercoat 36 may be configured to produce a CTE gradient. For example, the CTE of the outermost exterior overcoat layer 40B may be substantially different than a CTE of substrate 32. A composition of metal carbide for undercoat 36 and/or a composition, particle size, particle size distribution, or composition corresponding to the ceramic matrix of overcoat layers 40 may be selected to incrementally increase or decrease a CTE, such that a difference in CTE between adjacent layers may be reduced. In some examples, various overcoat layers 40 between an outermost exterior overcoat layer 40B and undercoat 36 may be configured to produce a thermal conductivity gradient. For example, the anticipated temperature experienced by the outermost layer may be substantially higher than desired for substrate 32. A composition or volume ratio of the composition of the ceramic matrix of overcoat layers 40 may be selected to reduce thermal conductivity, such that a heat flux (and temperature) through each subsequent overcoat layer 40 may be reduced.

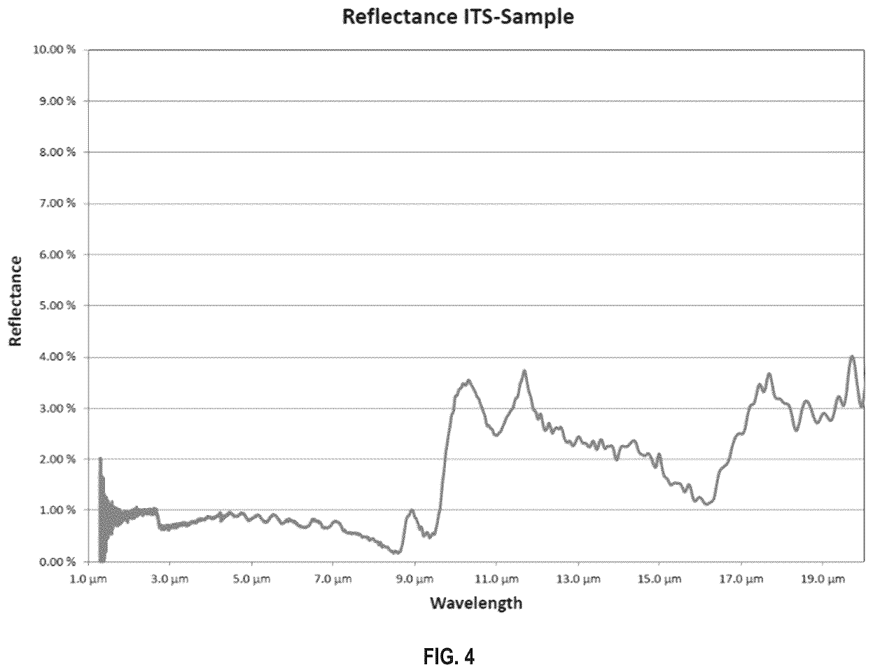

FIG. 4 illustrates the reflectance of an example component including a surface having a high temperature coating according to the present disclosure across a range of wavelengths. The reflectance of a sample in equal to 1 minus the emissivity of the samples. The reflectance of the sample at each wavelength is less than 5.00%, corresponding to emissivity values of greater than 0.95 for all measured wavelengths. The example component included a single overcoat layer which was 200 microns thick and formed from ytterbium disilicate.

Various examples have been described. These and other examples are within the scope of the following clauses and claims:
Clause 1: A space vehicle, the space vehicle includes a structural component defining a carbon-carbon composite substrate; a crystallized metal carbide undercoat on a surface of the carbon-carbon composite substrate; and an overcoat on a surface of the undercoat, wherein the overcoat comprises a high emissivity layer, wherein the high emissivity layer has a higher emissivity than the crystallized metal carbide undercoat, and wherein the high emissivity layer comprises a complex oxide.
Clause 2: The space vehicle of clause 1, wherein the high emissivity layer defines an interior surface and an exterior surface, and wherein the exterior surface has an emissivity of at least about 0.90 or at least about 0.95.
Clause 3: The space vehicle of clause 1 or clause 2, wherein the overcoat is a single layer consisting of the high emissivity layer, and wherein the high emissivity layer is relatively more abrasion resistant than the crystallized metal carbide undercoat and configured to protect the crystallized metal carbide undercoat from impact.
Clause 4: The space vehicle of clause 1 or clause 2, wherein the overcoat further comprises an abrasion resistant layer in addition to the high emissivity layer, wherein the abrasion resistant layer is different than the high emissivity layer and more abrasion resistant than the crystallized metal carbide undercoat.
Clause 5: The space vehicle of clause 4, wherein the high emissivity layer is the exterior layer of the overcoat.
Clause 6: The space vehicle of any of clauses 1-5, wherein a magnitude of the difference between a coefficient of thermal expansion (CTE) of the high emissivity layer of the overcoat and a CTE of the carbon-carbon composite substrate is less than 2 parts per million per degree Celsius (ppm/° C.).
Clause 7: The space vehicle of any of clauses 1-6, wherein the complex oxide of the high emissivity layer of the overcoat comprises a rare earth silicate.
Clause 8: The space vehicle of clause 7, wherein the complex oxide of the high emissivity layer of the overcoat comprises a rare earth disilicate.
Clause 9: The space vehicle of clause 7, wherein the complex oxide of the high emissivity layer of the overcoat comprises two or more rare earth cations.
Clause 10: The space vehicle of any of clauses 1-9, wherein the high emissivity layer comprises a ceramic matrix, and wherein the high emissivity layer comprises a plurality of high-emissivity particles dispersed in the ceramic matrix.
Clause 11: The space vehicle of any of clauses 1-10, wherein the overcoat comprises a plurality of overcoat layers, wherein at least two layers of the plurality of overcoat layers include a ceramic matrix having at least one of a different coefficient of thermal expansion or a different thermal conductivity.
Clause 12: A method includes forming a crystallized metal carbide undercoat on a surface of a carbon-carbon composite substrate of a structural component of a space vehicle; and forming an overcoat on a surface of the undercoat, wherein the overcoat comprises a high emissivity layer, wherein the high emissivity layer has a higher emissivity than the crystallized metal carbide undercoat, and wherein the high emissivity layer comprises a complex oxide.
Clause 13: The method of clause 12, wherein the high emissivity layer defines an interior surface and an exterior surface, and wherein the exterior surface has an emissivity of at least about 0.90 or at least about 0.95.
Clause 14: The method of clause 12 or clause 13, wherein forming the overcoat includes forming a single layer consisting of the high emissivity layer, and wherein the high emissivity layer is relatively more abrasion resistant than the crystallized metal carbide undercoat and configured to protect the crystallized metal carbide undercoat from impact.
Clause 15: The method of clause 12 or clause 13, wherein forming the overcoat further comprises forming an abrasion resistant layer in addition to the high emissivity layer, wherein the abrasion resistant layer is different than the high emissivity layer and more abrasion resistant than the crystallized metal carbide undercoat.
Clause 16: The method of clause 15, wherein the high emissivity layer is the exterior layer of the overcoat.
Clause 17: The method of any of clauses 12-16, wherein a magnitude of the difference between a coefficient of thermal expansion (CTE) of the high emissivity layer of the overcoat and a CTE of the carbon-carbon composite substrate is less than 2 parts per million per degree Celsius (ppm/° C.).
Clause 18: The method of any of clauses 12-17, wherein the complex oxide of the high emissivity layer of the overcoat comprises a rare earth silicate.
Clause 19: The method of clause 18, wherein the complex oxide of the high emissivity layer of the overcoat comprises a rare earth disilicate.
Clause 20: The method of clause 18, wherein the complex oxide of the high emissivity layer of the overcoat comprises two or more rare earth cations.
Clause 21: The method of any of clauses 12-20, wherein the high emissivity layer comprises a ceramic matrix, and wherein the high emissivity layer comprises a plurality of high-emissivity particles dispersed in the ceramic matrix.
Clause 22: The method of any of clauses 12-21, wherein forming the overcoat comprises sequentially forming a plurality of overcoat layers, wherein at least two layers of the plurality of overcoat layers include a ceramic matrix having at least one of a different coefficient of thermal expansion or a different thermal conductivity.
Clause 23: The method of any of clauses 12-22, wherein forming the overcoat comprises: applying a slurry to a surface of an underlying layer, wherein the slurry includes a complex oxide; and heating, in an inert atmosphere or under vacuum, the slurry to a heat treatment temperature to pyrolyze or evaporate components of the slurry to form the overcoat layer, wherein the overcoat layer comprises the complex oxide.

What is claimed is:

1. A space vehicle, the space vehicle comprising:
a structural component defining a carbon-carbon composite substrate;
a crystallized metal carbide undercoat on a surface of the carbon-carbon composite substrate; and
an overcoat on a surface of the undercoat, wherein the overcoat comprises a high emissivity layer, wherein the high emissivity layer has a higher emissivity than the crystallized metal carbide undercoat, and wherein the high emissivity layer comprises a complex oxide.

2. The space vehicle of claim 1, wherein the high emissivity layer defines an interior surface and an exterior surface, and wherein the exterior surface has an emissivity of at least about 0.90 or at least about 0.95.

3. The space vehicle of claim 1, wherein the overcoat is a single layer consisting of the high emissivity layer, and wherein the high emissivity layer is relatively more abrasion resistant than the crystallized metal carbide undercoat and configured to protect the crystallized metal carbide undercoat from impact.

4. The space vehicle of claim 1, wherein the overcoat further comprises an abrasion resistant layer in addition to the high emissivity layer, wherein the abrasion resistant layer is different than the high emissivity layer and more abrasion resistant than the crystallized metal carbide undercoat.

5. The space vehicle of claim 4, wherein the high emissivity layer is the exterior layer of the overcoat.

6. The space vehicle of claim 1, wherein a magnitude of the difference between a coefficient of thermal expansion (CTE) of the high emissivity layer of the overcoat and a CTE of the carbon-carbon composite substrate is less than 2 parts per million per degree Celsius (ppm/° C.).

7. The space vehicle of claim 1, wherein the complex oxide of the high emissivity layer of the overcoat comprises a rare earth silicate.

8. The space vehicle of claim 7, wherein the complex oxide of the high emissivity layer of the overcoat comprises a rare earth disilicate.

9. The space vehicle of claim 7, wherein the complex oxide of the high emissivity layer of the overcoat comprises two or more rare earth cations.

10. The space vehicle of claim 1, wherein the high emissivity layer comprises a ceramic matrix, and wherein the high emissivity layer comprises a plurality of high-emissivity particles dispersed in the ceramic matrix.

11. The space vehicle of claim 1, wherein the overcoat comprises a plurality of overcoat layers, wherein at least two layers of the plurality of overcoat layers include a ceramic matrix having at least one of a different coefficient of thermal expansion or a different thermal conductivity.

12. A method comprising:
forming a crystallized metal carbide undercoat on a surface of a carbon-carbon composite substrate of a structural component of a space vehicle; and
forming an overcoat on a surface of the undercoat, wherein the overcoat comprises a high emissivity layer, wherein the high emissivity layer has a higher emissivity than the crystallized metal carbide undercoat, and wherein the high emissivity layer comprises a complex oxide.

13. The method of claim 12, wherein the high emissivity layer defines an interior surface and an exterior surface, and wherein the exterior surface has an emissivity of at least about 0.90 or at least about 0.95.

14. The method of claim 12, wherein forming the overcoat includes forming a single layer consisting of the high emissivity layer, and wherein the high emissivity layer is relatively more abrasion resistant than the crystallized metal carbide undercoat and configured to protect the crystallized metal carbide undercoat from impact.

15. The method of claim 12, wherein forming the overcoat further comprises forming an abrasion resistant layer in addition to the high emissivity layer, wherein the abrasion resistant layer is different than the high emissivity layer and more abrasion resistant than the crystallized metal carbide undercoat.

16. The method of claim 15, wherein the high emissivity layer is the exterior layer of the overcoat.

17. The method of claim 12, wherein a magnitude of the difference between a coefficient of thermal expansion (CTE) of the high emissivity layer of the overcoat and a CTE of the carbon-carbon composite substrate is less than 2 parts per million per degree Celsius (ppm/° C.).

18. The method of claim 12, wherein the complex oxide of the high emissivity layer of the overcoat comprises a rare earth silicate.

19. The method of claim 18, wherein the complex oxide of the high emissivity layer of the overcoat comprises a rare earth disilicate.

20. The method of claim 18, wherein the complex oxide of the high emissivity layer of the overcoat comprises two or more rare earth cations.
